(19) United States
(12) Patent Application Publication
(10) Pub. No.: US 2018/0185997 A1
(43) Pub. Date: Jul. 5, 2018

(54) INSERTION METHOD, TOOL, AND DOUBLE SEALING FITTING

(71) Applicant: FLEX PIPING SOLUTIONS, LLC, Cincinnati, OH (US)

(72) Inventors: James H. Burton, Reading, PA (US); Brian M. Swift, Cincinnati, OH (US)

(21) Appl. No.: 15/862,082

(22) Filed: Jan. 4, 2018

Related U.S. Application Data
(60) Provisional application No. 62/442,147, filed on Jan. 4, 2017.

(51) Int. Cl. B25B 27/10; F16L 33/207

(52) U.S. Cl. CPC B25B 27/10; F16L 33/2071

(57) ABSTRACT

Methods, tools, and systems are described to allow cost effective field/on-site installation of connectors to flexible tubes/hoses for the transfer of various higher-pressure mediums. An economical means for preparing the tube/hose to receive a fitting stem with an optional retention ring allows installers to prepare assemblies in the field/on-site and provides a method for securely attaching the fitting to the tube/hose to withstand higher working pressures without using elastomeric rings or adhesives. Tooling described is portable and capable of use in confined areas. Additionally a method for increasing the number of sealing positions contained in the fitting dramatically reduces the number of installation leaks and allows for higher operating pressures.

### CROSS-REFERENCE TO RELATED APPLICATION

This application claims priority to U.S. Provisional Application No. 62/442,147, which was filed Jan. 4, 2017, the entire contents of which are incorporated herein by reference.

### BACKGROUND OF THE INVENTION

The present invention relates, generally, to fittings for flexible tubes/hoses, and more specifically to field/on-site connection fitting installation onto flexible tubes/hoses used in the air-conditioning, refrigeration, heat transfer, and other medium transport systems.

The field/on-site installation of connection fittings capable of handling high working pressures is a problem that has limited the use of lower cost tubes/hoses in the air-conditioning and related industries. The methods used to-date have two significant limiting factors. First, either the connection fittings are complex and costly or require adhesives. Second, the compression systems used to join the connection fitting to the tube/hose are not intended or compatible for use in the field/on-site. This results in cost prohibitive connectors and connections that need to be completed away from the job-site.

Various devices are known for installing connectors onto flexible tubes/hoses. But, using these known devices, the complexity of the connection fitting and the use of adhesives result in costly components that do not lend themselves to reliable installation in the field/on-site. In some cases, installing the connectors requires significant force that must be exerted in a large stationary platform that is not portable

Thus, a cost effective means of joining connection fittings to flexible tubes/hoses in the field/on-site is needed to improve the quality, efficiency, and cost effectiveness of these systems.

### BRIEF SUMMARY OF THE INVENTION

In some embodiments, a method, expansion/insertion tool, and double sealing fitting for field/on-site installation of connectors to flexible tubes/hoses capable of withstanding the high pressures required for heat transfer mediums are provided. In further embodiments, the method may use the expansion/insertion tool to prepare a tube/hose by warming and expanding the tube/hose inner surface, allowing for a greater interference fit of the fitting stem, and to insert the fitting stem into the tube/hose.

In some embodiments, the expansion/insertion tool may comprise one or more shaft sections, such as an initial expansion section and an insert length section of varying diameters. The expansion/insertion tool may also incorporate a shaft assisted rotational section that may securely attach to a drill or similar device. Other embodiments may have fewer or more shaft sections.

In some embodiments, a double sealing fitting connector may have two sealing sections to insure a secure connection of the fitting to the subject fixture. The double sealing fitting may comprise a stem mating face section that mirrors the subject fixture and a stem pocket seal face that mate with the nut or locking pocket seal section.

### BRIEF DESCRIPTION OF THE DRAWINGS

FIG. 1 shows a side perspective view of an example of an expansion/insertion tool according to various embodiments described herein.

FIG. 2 illustrates a side view and a sectional view of an example of a fitting stem according to various embodiments described herein.

FIG. 3 presents an example of a nut or locking fitting pocket seal section according to various embodiments described herein.

FIG. 4 illustrates a side view and a sectional view of an example of a fitting stem with retention ring according to various embodiments described herein.

FIG. 5 illustrates a side view and a sectional view of an example of a collar including contact ridges according to various embodiments described herein.

### DETAILED DESCRIPTION AND BEST MODE OF IMPLEMENTATION

The disclosed method, expansion/insertion tool, fitting and system provides for the installation of gas, fluid, and other medium transfer systems capable of operating at high working pressures within tubes/hoses in the field/on-site.

Expansion/Insertion Tool Embodiments:

The following section describes an expansion/insertion tool, which has two different, yet related, means of expanding an internal diameter of the tube/hose into which the fitting is being placed. First, the expansion/insertion tool can be used to expand an internal diameter of the tube/hose, via one or more expansion sections having an outer diameter larger than the internal diameter of the tubes/hoses, such that the fittings described more fully below may be more easily inserted into the tubes/hoses. The expansion/insertion tool may also serve a related, but different, purpose of heating the tube/hose to soften it. Although a heat gun or other electrical means of heating the tube may be used, many field environments do not have easily accessible power sources. However, the expansion/insertion tool may be used to generate heat from friction by rapidly rotating the expansion/insertion tool in the internal diameter of the tubes/hoses.

The expansion/insertion tool may also be directly used for inserting the fitting into the tube/hose. As noted previously, the expansion/insertion tool includes various sections. The first section may have an outer diameter that is less than the internal diameter of the fitting to be applied to the tube/hose. However subsequent sections of the expansion/insertion tool may have an outer diameter that is greater than the internal diameter of the fitting. To begin inserting the fitting stem into the tube/hose, the expansion/insertion tool may be removed from the tube/hose after being used to expand the internal diameter of the tube/hose, as described above. Then, the first section having an outer diameter that is less than the internal diameter of the fitting may be inserted into the fitting until the subsequent section of the expansion/insertion tool having an outer diameter that is greater than the internal diameter of the fitting comes into contact with part of the fitting to prevent further progression of the tool into the fitting, where the first section is at least partially disposed within the fitting stem when such progression is stopped. The expansion/insertion tool can, thus, be used to push the fitting stem into the internal diameter of the tube/hose. In short, the expansion/insertion tool allows a convenient location for applying force for placing the fitting stem into the tube/hose.

The ferrule, sleeve, crimp collar or similar locking device may then be secured to the tube/hose either prior to, or subsequently after, removing the expansion/insertion tool from the now properly placed fitting. Once the ferrule, sleeve, crimp collar or similar locking device is in place, a crimping device may be used to complete the process of securing the fitting to the tube/hose. Because the fitting stem should not be deformed in in this final step, the expansion/insertion tool may remain inside the fitting throughout the securing process, thus providing a convenient gripping location for the field technician, although it may also be removed before securing the ferrule, sleeve, crimp collar or similar locking device.

Now, the expansion/insertion tool will be explained in greater detail through the use of an exemplary embodiment.

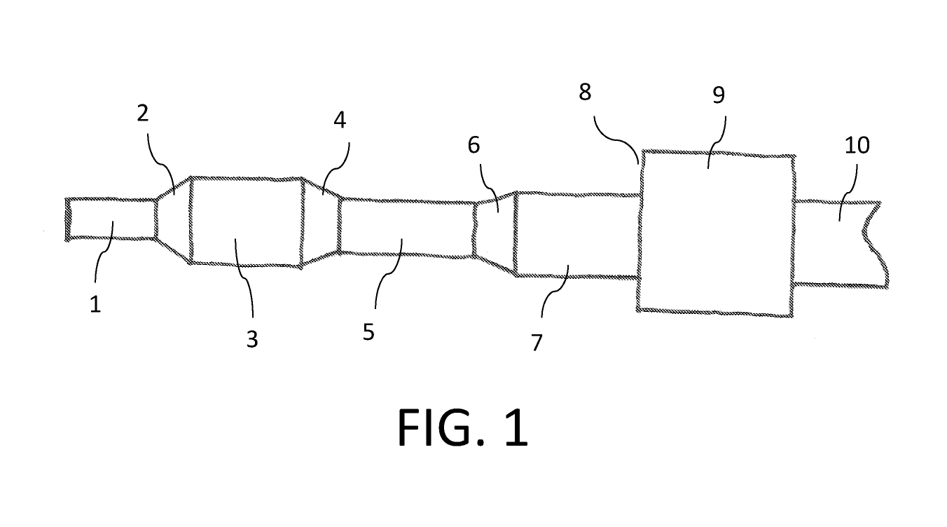

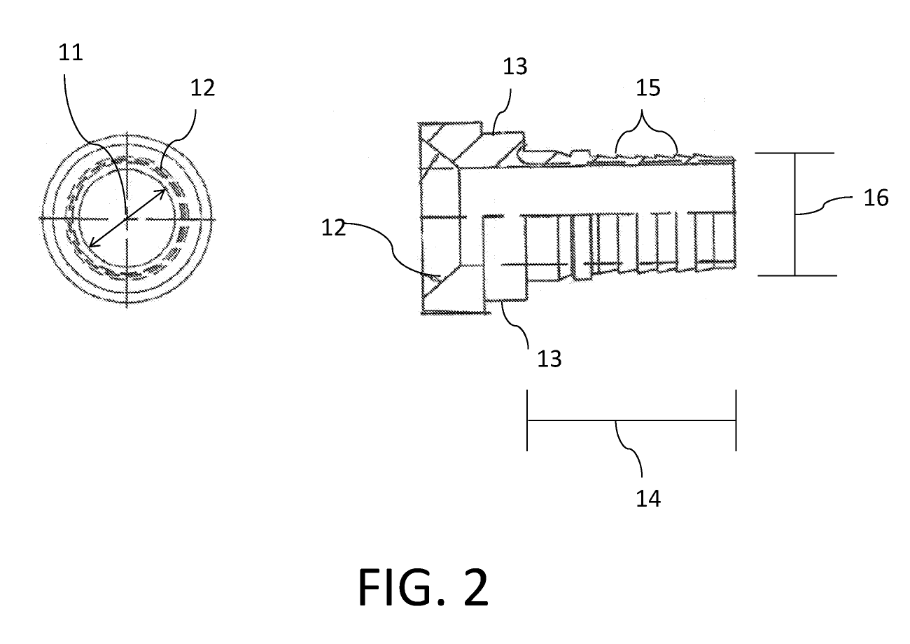

FIG. 1 shows a side perspective view of an example of an expansion/insertion tool used to prepare the hose and to insert the fitting according to various embodiments described herein. In some embodiments, the tool may comprise one or more, such as ten, shaft sections. The tube/hose insertion guide section 1 may have an outside diameter smaller than the internal diameter of the fitting stem (best shown in FIG. 2). Optionally, the shaft initial expansion taper section 2 may uniformly transition from the outside diameter of the shaft tube/hose insertion guide section to the outside diameter of the shaft initial expansion section 3. The shaft initial expansion 3 and secondary expansion 7 sections may have an outside diameter larger than the internal diameter of the tube/hose. Optionally, the shaft expansion relief section 4 outside diameter may taper uniformly from the shaft initial expansion section 3 outside diameter to the shaft insert length section 5 outside diameter. Optionally, the secondary expansion taper section 6 may uniformly transition from the outside diameter of the shaft insert length section 5 to the outside diameter of the shaft secondary expansion section 7.

In the embodiment shown, the shaft secondary expansion section 7 meets squarely with the shaft tube/hose stop section 8, but the secondary expansion section 7 may include a shaft secondary expansion relief section, as well.

The combined length of the shaft section insert length section 5 plus shaft secondary expansion taper section 6 plus shaft secondary expansion section 7 ending at the tube/hose stop 8 approximates the length of the fitting insert section 14 (best shown in FIG. 2), although such dimensions are not required. Multiple shaft expansion sections may be included. In FIG. 1, two shaft expansion sections are shown, one shaft initial expansion section and one shaft secondary expansion section. However, the expansion/insertion tool may include 1, 2, 3, 4, 5, or even more shaft expansion sections.

Manual rotational section 9 may be used to manually turn the expansion/insertion tool. In some embodiments, the method may comprise using the expansion/insertion tool attached to a drill or similar device by attaching the assisted rotational section 10 in the chuck of a drill or other similar tool, to provide rotational force when inserting the tool into the inside diameter of the tube/hose to warm and expand the tube/hose that will carry the transfer medium. Assisted rotational section 10 may be sized to securely attach to a drill or similar device. In some embodiments, the diameters and lengths of the various shaft sections of the expansion/insertion tool may be coordinated with the hose and fitting combinations. In alternative embodiments, the various shaft sections of the expansion/insertion tool may be formed as one continuous unit or multiple sections joined together.

In some embodiments, the expansion/insertion tool may be attached to a drill or similar device to create rotational friction when placed in contact with the internal diameter of the tube/hose to warm and expand the tube/hose, thus assisting in inserting the fitting stem. The fitting stem outside diameter may have an interference fit to the tube/hose internal diameter.

In further embodiments, the expansion/insertion tool may comprise: a shaft tube/hose insertion guide section 1 with said shaft section having an outside diameter smaller than the internal diameter of the fitting stem; a shaft initial expansion taper section 2 with said shaft section having a uniform outside diameter taper; a shaft initial expansion section 3 with said shaft section having an outside diameter larger than the internal diameter of the tube/hose; a shaft expansion relief section 4 with said shaft section having a uniform outside taper; a shaft insert length section 5 with said shaft section of uniform outside diameter less than the inside diameter of the tube/hose; a shaft secondary expansion taper section 6 with said shaft section having a uniform outside diameter taper; a shaft secondary expansion section 7 with said shaft section having an outside diameter larger than the internal diameter of the tube/hose; a shaft tube/hose stop section 8 that prohibits the further insertion of the expansion/insertion tool into the tube/hose inside diameter; a manual rotational section 9 which may be used for manual turning of the expansion/insertion tool; and an assisted rotational section 10 sized to securely attach to a drill or similar device.

The expansion/insertion tool shown in FIG. 1 may be made from rigid substances such as metals, alloys, plastics, fibers, or any substance which will retain its shape as the expansion/insertion tool is inserted into the tube/hose inside diameter.

In some embodiments, the expansion/insertion tool may be sized to its various dimensions by machining, casting, stamping, 3-D printing, forming, or other means of producing the required dimensions of the tool for the various tube/hose and fitting combinations. Other methods may provide expansion/insertion tooling capable of being used for multiple tube/hose and fitting combinations.

Following the removal of the expansion/insertion tool from the tube/hose, a ferrule, sleeve, crimp collar or similar locking device may be placed over the outside diameter of the tube/hose.

Embodiments Without a Retention Ring:

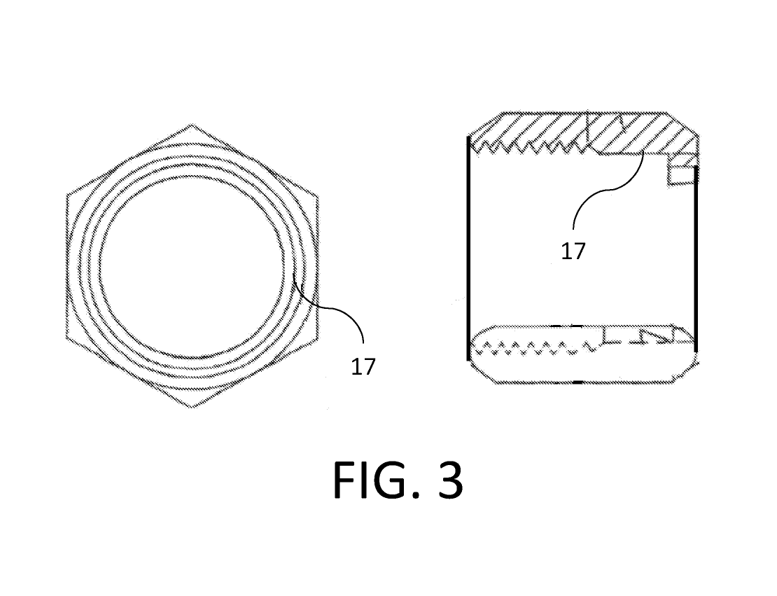

FIG. 2 illustrates a side view and a sectional view of an example of a fitting stem according to various embodiments described herein. In some embodiments, the sizing of the stem may comprise an inside diameter 11 through which the medium will flow, a length of fitting insert section 14, and a stem outside diameter 16 greater than the tube/hose internal diameter, providing for an interference fit. In some embodiments, the outside and inside diameters and lengths of the various fitting stems are coordinated with the hose and medium combinations. Additionally the stem may comprise a stem mating face 12 to form a mating connection with a subject fixture and a stem pocket seal section 13 to form a mating connection with the nut or locking fitting pocket seal section 17 (best shown in FIG. 3). The uneven outside surface 15 may assist in preventing the tube/hose from moving longitudinally relative to the fitting stem. In alternative embodiments, the various sections of the fitting stem can be made as one continuous unit or multiple sections joined together.

In some embodiments, a double sealing fitting connector, nut or locking fitting, may provide two fitting sealing points to achieve higher pressure performance with installed tubes/hoses and to reduce installation failures. In further embodiments, the double sealing fitting connector, nut or locking fitting, may comprise: a stem mating face seal 12 of any one of many styles, including threaded, press-on, angled, male, and female, to form a mating connection with a subject fixture; a stem pocket seal 13 section; and a nut or locking fitting pocket seal section 17.

In some embodiments, the fitting stem shown in FIG. 2 may be affixed to the expansion/insertion tool shown in FIG. 1 by inserting the shaft tube/hose insertion guide section 1 of the expansion/insertion tool through the inside diameter 11 of the fitting stem up to the initial expansion taper section 2 on the expansion/insertion tool. In further embodiments, the expansion/insertion tool may then be used to insert the fitting stem into the inside diameter of the tube/hose by rotational force, direct force, or any other means of applying pressure.

The uneven outside surface 15 of the outside diameter 16 may be greater than the inside diameter of the tube/hose, providing an interference fit to the connection. In some embodiments, the uneven outside surface 15 has ridges, teeth, knurls, spirals, barbs, raised texturing, and/or other methods of creating the uneven outside surface 15. The depth of these ridges, teeth, knurls, spirals, barbs, raised texturing, and/or other methods of creating the uneven outside surface 15 relative to the outer surface of the fitting stem may be varied to provide the best possible attachment to the tube/hose. Greater depth of the ridges, teeth, knurls, spirals, barbs, raised texturing, and/or other methods of creating the uneven outside surface 15 increases the contact of the fitting with the tube/hose, and thus increases the strength of the attachment of the two components.

In some embodiments, the fitting stem can be made of metals, alloys, plastics, fibers, any substance which will retain its shape and can be sized to various dimensions by machining, casting, stamping, 3-D printing, forming or other means of producing the required dimensions of the fitting stem. In alternative embodiments the various sections of the fitting stem can be made as one continuous unit or multiple sections joined together.

In some embodiments, the expansion/insertion tool may be removed from the fitting stem before affixing of the ferrule, sleeve, crimp collar, or similar locking device to the tube/hose assembly. In other embodiments, the expansion/insertion tool may remain in the fitting stem while affixing of the ferrule, sleeve, crimp collar, or similar locking device to the tube/hose assembly.

The ferrule, sleeve, crimp collar, or similar locking device may be made from rigid substances such as metals, alloys (e.g., brass), plastics, fibers, or any substance which will maintain structural integrity as the ferrule, sleeve, crimp collar, or similar locking device is crimped, compressed, swaged, or deformed. The ferrule, sleeve, crimp collar, or similar locking device may be of various thicknesses, with thicker components being less prone to breakage but with thinner components requiring less force to crimp, compress, swage, or deform the component.

In some methods, the ferrule, sleeve, crimp collar, or similar locking device is crimped, compressed, swaged, or deformed, thus inwardly securing the ferrule or similar locking device with the tube/hose locked against longitudinal movement relative to the fitting stem between the fitting stem and ferrule, sleeve, crimp collar, or similar locking device. Ferrule/sleeve locking devices are available from numerous manufacturers such as Parker, Gates, Goodyear, Dixon, HydraHose, etc. The crimping, compressing, swaging, deforming, threading, securing of the ferrule, sleeve, crimp collar, or similar locking device to the assembly compresses inwardly and embeds the uneven outside surface 15 of fitting stem into the inner surface of the tube/hose. This prevents the tube/hose from longitudinal movement relative to the fitting stem, locking the tube/hose between the fitting stem and ferrule, sleeve, crimp collar, or similar locking device.

A method of crimping, compressing, swaging, deforming, securing the ferrule or similar locking device to the tube/hose can be achieved using manual, Pro Press, portable, or stationary crimping systems available from Milwaukee, Rigid, NIBCO, Parker, Weatherhead, or any other methods utilizing crimp heads or tongs from suppliers such as REMS. Other crimpers may be used depending on the needs of the particular application.

Other embodiments comprising this method apply to other connecting items including, but not limited to, male, female, flare, sweat, coupler, reducer, expander, “Y” joint, joint, multiple joint, manifold, or other connecting item.

In some embodiments the increased pressure performance and reduced installation failures of the assembly are achieved by utilizing a double sealing fitting connector, nut or locking fitting, that provides two fitting sealing points within the fitting assembly (i.e., the fitting stem and nut or locking device, as shown in FIGS. 2 and 3). Other methods include the use of sealing rings made of elastomeric and other similar materials. Still other methods increase the number of sealing points beyond a mere two. The scope of the claimed invention is not limited by the number of sealing points as any number of sealing points may be utilized.

Various methods include a stem mating face seal 12 of any one of many styles, including threaded, press-on, angled (as shown in FIG. 2), and male/female, to form a mating connection with a subject fixture.

In other embodiments, a second sealing point may be established between the stem pocket seal section 13 (best shown in FIG. 2) and the nut or locking fitting pocket seal section 17 (best shown in FIG. 3) The stem pocket seal section 13 may mate with the nut or locking fitting pocket seal section 17.

In some embodiments, the nut or locking fitting (FIG. 3) can be made of metals, alloys, plastics, fibers, any substance which will retain its shape and can be sized to various dimensions by machining, casting, stamping, 3-D printing, forming or other means of producing the required dimensions of the nut or locking fitting. In alternative embodiments the various sections of the nut or locking fitting can be made as one continuous unit or multiple sections joined together.

In other embodiments, the fitting stem and nut or locking fitting can be made of differing materials.

In some embodiments, a method for field/on-sight installation of fittings into flexible tubes/hoses that can withstand high-pressure applications is provided. The method may comprise the steps of:

inserting and optionally moving, such as by rotation, the expansion/insertion tool longitudinally on the internal diameter of the tube/hose to expand and warm the tube/hose;

applying a ferrule, sleeve, crimp collar, or similar locking device to the exterior of the tube/hose;

inserting the expansion/insertion tool through the internal diameter of the fitting;

inserting the fitting stem on the expansion/insertion tool into the inner diameter of the tube/hose; and

crimping, compressing, swaging, deforming, threading, or otherwise securing the ferrule, sleeve, crimp collar, or similar locking device with the tube/hose locked against longitudinal movement relative to the fitting stem between the fitting stem and ferrule, sleeve, crimp collar, or similar locking device.

Various methods can be used for the formation of field/on-site installation of fitting connections to meet the requirements of this application and are not limited by dimensions, materials, tubes/hoses types or constructions, tooling (manual, mechanical, electrical, hydraulic systems), applications, or mediums transported.

Embodiments with a Retention Ring

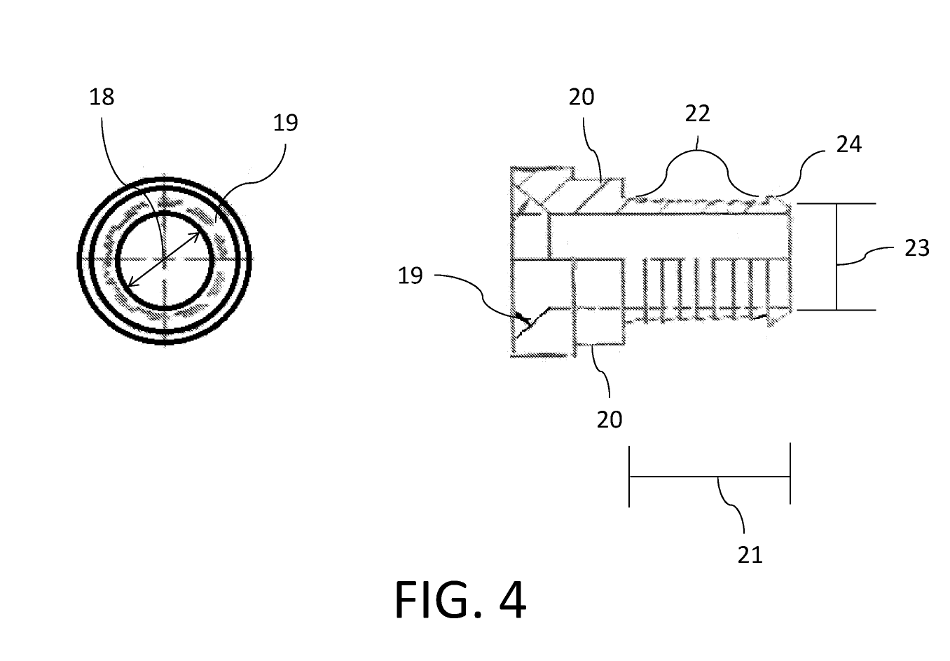

FIG. 4 illustrates a side view and a sectional view of an example of a fitting stem with a retention ring 24 according to various embodiments described herein. In some embodiments, the sizing of the stem may comprise an inside diameter 18 through which the medium will flow, the length of fitting insert section 21, and a stem outside diameter 23 greater than the tube/hose internal diameter, which may provide for an interference or frictional fit with a tube/hose. In some embodiments the retention ring 24 outside diameter may be greater than the stem outside diameter and the tube/hose internal diameter, providing for an interference fit with a tube/hose. Additionally this area behind the retention ring 24 may provide a locking area for one or more ferrules, sleeves, crimp collars, or other similar locking devices. The length of the retention ring 24 may be selected based on the desired outcome of the particular application for which it is used. In some embodiments the outside and inside diameters and lengths of the various fitting stems and retention ring may be of any shape and size so that they may be coordinated with any hose and medium combinations.

Additionally, the stem may comprise a stem mating face 19 which may form a mating connection with a subject fixture, and a stem pocket seal section 20 which may form a mating connection with a nut or locking fitting pocket seal section 17 (best shown in FIG. 3). An uneven or textured outside surface 22 may assist in preventing the tube/hose from moving longitudinally relative to the fitting stem. Similarly, the larger diameter retention ring 24 may assist in preventing the tube/hose from moving longitudinally relative to the fitting stem.

In alternative embodiments the various sections of the fitting stem can be made or formed as one continuous unit while in further embodiments, two or multiple sections of the fitting stem may be coupled or joined together.

In some embodiments, a double sealing fitting connector, nut or locking fitting, may provide two or more fitting sealing points to achieve higher pressure performance with installed tubes/hoses and reduce installation failures. In further embodiments, the double sealing fitting connector, nut or locking fitting, may comprise: a stem mating face seal 19 of many styles, including threaded, press-on, angled (as shown in FIG. 4), and male/female, to form a mating connection with a subject fixture; a stem pocket seal section 20; and a nut or locking fitting pocket seal section 17.

In some embodiments the fitting stem (shown in FIG. 4) may be affixed to the expansion/insertion tool (shown in FIG. 1) by inserting the shaft tube/hose insertion guide section 1 of the expansion/insertion tool through the inside diameter 18 of the fitting stem up to the initial expansion taper section 2 on the expansion/insertion tool. In further embodiments, the expansion/insertion tool may then be used to insert the fitting stem into the inside diameter of the tube/hose by rotational force, direct force, or other means of applying pressure.

The uneven outside surface 22 of outside diameter 23 may be greater than the inside diameter of the tube/hose providing an interference fit to the connection. In some embodiments, the uneven outside surface 22 may include ridges, teeth, knurls, spirals, barbs, raised texturing, and/or other methods of creating the uneven outside surface 22. The depth of these ridges, teeth, knurls, spirals, barbs, raised texturing, and/or other methods of creating the uneven outside surface 22 relative to the outer surface of the fitting stem may be varied to provide the best possible attachment to tube/hose. Greater depth of the ridges, teeth, knurls, spirals, barbs, raised texturing, and/or other methods of creating the uneven outside surface 22 increases the contact of the fitting with the tube/hose, and thus increases the attachment of the two components.

The retention ring 24 outside diameter may be greater than the stem outside diameter 23 and the tube/hose internal diameter providing an interference fit to the connection.

In some embodiments, the fitting stem and retention ring can be made of metals, alloys, plastics, fibers, any substance which will retain its shape and can be sized to various dimensions by machining, casting, stamping, 3-D printing, forming or other means of producing the required dimensions of the fitting stem. In alternative embodiments the various sections of the fitting stem and retention ring can be made as one continuous unit or multiple sections joined together.

In some embodiments, the expansion/insertion tool may be removed from the fitting stem before affixing of the ferrule, sleeve, crimp collar, or similar locking device to the tube/hose assembly. In other embodiments, the expansion/insertion tool may remain in the fitting stem while affixing of the ferrule, sleeve, crimp collar, or similar locking device to the tube/hose assembly.

In some methods, the ferrule, sleeve, crimp collar, or similar locking device is then crimped, compressed, swaged, deformed, or the like thereby inwardly securing the ferrule, sleeve, crimp collar, or similar locking device with the tube/hose locked against longitudinal movement relative to the fitting stem between the fitting stem and ferrule, sleeve, crimp collar, or similar locking device and behind the retention ring. Ferrule/sleeve locking devices which may be used are available from numerous manufacturers such as Parker, Gates, Goodyear, Dixon, HydraHose, etc. The crimping, compressing, swaging, deforming, threading, securing of the ferrule, sleeve, crimp collar, or similar locking device to the assembly compresses inwardly and may embed the uneven outside surface 22 of fitting stem into the inner surface of the tube/hose and behind the retention ring 24. This may prevent the tube/hose from longitudinal movement relative to the fitting stem, locking the tube/hose between the fitting stem and ferrule, sleeve, crimp collar, or similar locking device and behind the retention ring.

A method of crimping, compressing, swaging, deforming, securing the ferrule or similar locking device to the tube/hose can be achieved using manual, portable, or stationary crimping systems such as those available from Milwaukee, Rigid, NIBCO, Parker, Weatherhead, Finnpower, Pyplock, Lillbacka or any other methods utilizing crimp heads, dies, or tongs from suppliers such as REMS.

Other embodiments comprising this method apply to other connecting items including, but not limited to, male, female, flare, sweat, coupler, reducer, expander, “Y” joint, joint, multiple joint, manifold, or other connecting item.

In some embodiments, the increased pressure performance and reduced installation failures of the assembly are achieved by utilizing a double sealing fitting connector, nut or locking fitting, that provides two fitting sealing points within the fitting assembly (i.e., the fitting stem and nut or locking device, as shown in FIGS. 3 and 4). Other methods include the use of sealing rings made of elastomeric and other similar materials. Still other methods increase the number of sealing points beyond a mere two. The scope of the claimed invention is not limited by the number of sealing points as any number of sealing points may be utilized.

Embodiments of various methods may include a stem mating face seal 19 of many styles, including threaded, press-on, angled (as shown in FIG. 4), and male/female, to form a mating connection with a subject fixture.

In some embodiments, a second sealing point may be established between the stem pocket seal 20 section (FIG. 4) and the nut or locking fitting pocket seal section 17 (best shown in FIG. 3). The stem pocket seal 20 section may mate with the nut or locking fitting pocket seal section 17.

In some embodiments, the nut or locking fitting (FIG. 3) can be made of metals, alloys, plastics, fibers, any substance which will retain its shape and can be sized to various dimensions by machining, casting, stamping, 3-D printing, forming or other means of producing the required dimensions of the nut or locking fitting. In alternative embodiments, the various sections of the nut or locking fitting can be made as one continuous unit or formed by multiple sections which may be joined together.

In other embodiments, the fitting stem, retention ring, and nut or locking fitting can be made of differing materials.

In some embodiments, a method for field/on-sight installation of fittings into flexible tubes/hoses that can withstand high-pressure applications is provided. The method may comprise the steps of:

inserting and optionally moving, such as by rotation, the expansion/insertion tool longitudinally on the internal diameter of the tube/hose to expand and warm the tube/hose;

applying a ferrule, sleeve, crimp collar, or similar locking device to the exterior of the tube/hose;

inserting the expansion/insertion tool through the internal diameter of the fitting with retention ring;

inserting the fitting stem with retention ring on the expansion/insertion tool into the inner diameter of the tube/hose; and

crimping, compressing, swaging, deforming, threading, or otherwise securing the ferrule or similar locking device with the tube/hose locked against longitudinal movement relative to the fitting stem between the fitting stem and ferrule, sleeve, crimp collar, or similar locking device behind the retention ring.

Various methods can be used for the formation of field/on-site installation of fitting connections to meet the requirements of this application and are not limited by dimensions, materials, tube/hose types or constructions, tooling (manual, mechanical, electrical, or hydraulic systems), applications, or mediums transported.

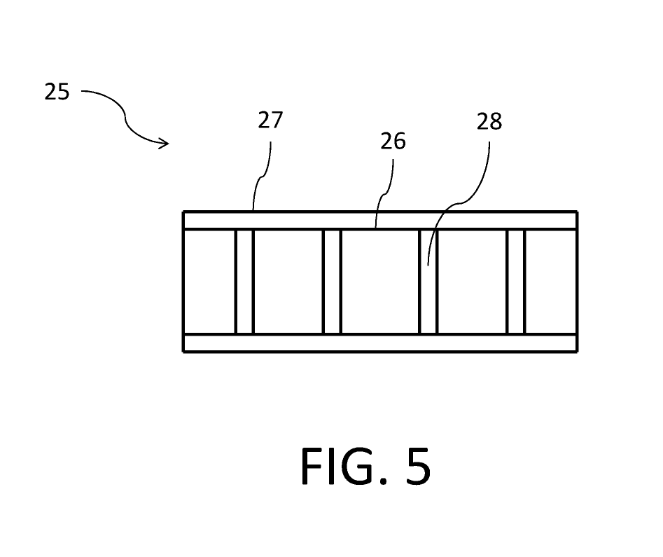

FIG. 5 shows a side view of an alternative embodiment of the ferrule, sleeve, crimp collar or similar locking device 25. In the embodiment shown, the ferrule, sleeve, crimp collar, or similar locking device 25 comprises an inner surface 26, an outer surface 27, and a set of ridges 28 on the inner surface, which operate to more strongly attach to the tube/hose once affixed to the tube/hose. Thus, a stronger connection between the ferrule, sleeve, crimp collar, or similar locking device 25 and the tube/hose may be attained.

The number of ridges 28 present may be 0-10, 1-9, 2-8, 3-7, 4-6, or 5. Thus, the number of ridges 28 may be 0, 1, 2, 3, 4, 5, 6, 7, 8, 9, or 10.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

While the invention has been illustrated by a description of various embodiments and while these embodiments have been described in considerable detail, it is not the intention of the applicant to restrict or in any way limit the scope of the appended claims to such detail. Additional advantages and modifications will readily appear to those skilled in the art. Thus, the invention in its broader aspects is therefore not limited to the specific details, representative apparatus and method, and illustrative examples shown and described. Accordingly, departures may be made from such details without departing from the spirit or scope of applicants' general inventive concept.

We claim:

1. A method for field/on-sight installation of a fitting into a flexible tube/hose that can withstand high pressure applications, the method comprising:
inserting and moving the expansion/insertion tool longitudinally on an internal diameter of the tube/hose;
applying a ferrule, sleeve, crimp collar or similar locking device to an exterior of the tube/hose;
inserting a fitting stem into the inner diameter of the tube/hose; and
crimping, compressing, swaging, deforming, threading, or otherwise securing the ferrule, sleeve, crimp collar or similar locking device with the tube/hose locked against longitudinal movement relative to the fitting stem between the fitting stem and ferrule, sleeve, crimp collar or similar locking device.

2. The method of claim 1 wherein the ferrule, sleeve, crimp collar or similar locking device includes an inner surface, and the inner surface includes one or more ridges.

3. The method of claim 2 wherein the inner surface includes three ridges.

4. The method of claim 1 wherein the fitting includes a retention ring proximate to an end of the fitting.

5. The method of claim 4 wherein the ferrule, sleeve, crimp collar or similar locking device is crimped, compressed, swaged, deformed, threaded, or otherwise secured to the tube/hose behind the retention ring.

6. The method of claim 1 further comprising inserting the expansion/insertion tool into an internal diameter of the fitting prior to inserting the fitting stem into the inner diameter of the tube/hose.

7. An expansion/insertion tool comprising;
a shaft tube/hose insertion guide section with said shaft tube/hose insertion guide section having an outside diameter smaller than an internal diameter of the fitting stem;
a shaft initial expansion taper section with said shaft initial expansion taper section having a uniform outside diameter taper;
a shaft initial expansion section with said shaft initial expansion section having an outside diameter larger than an internal diameter of the tube/hose;
a shaft expansion relief section with said shaft expansion relief section having a uniform outside taper;
a shaft insert length section with said shaft insert length section of uniform outside diameter less than the internal diameter of the tube/hose; and
a shaft tube/hose stop section that prohibits further insertion of the expansion/insertion tool into the internal diameter of the tube/hose.

8. The expansion/insertion tool of claim 7 further comprising
a shaft secondary expansion taper section with said shaft secondary expansion taper section having a uniform outside diameter taper; and
a shaft secondary expansion section with said shaft secondary expansion section having an outside diameter larger than the internal diameter of the tube/hose;
wherein the shaft secondary expansion taper section and the shaft secondary expansion section are between the shaft insert length section and the shaft tube/hose stop.

9. The expansion/insertion tool of claim 7 further comprising a manual rotational section which may be used for manual turning of the expansion/insertion tool.

10. The expansion/insertion tool of claim 7 further comprising an assisted rotational section sized to securely attach to a drill or similar device.

11. The expansion/insertion tool of claim 8 comprising:
the shaft secondary expansion taper section;
the shaft secondary expansion section;
the shaft secondary expansion relief section;
a manual rotational section which may be used for manual turning of the expansion/insertion tool; and
an assisted rotational section sized to securely attach to a drill or similar device.

12. A fitting for flexible tubes/hoses comprising:
a fitting stem; and
a ferrule, sleeve, crimp collar or similar locking device.

13. The fitting of claim 12 wherein the fitting stem comprises an uneven outside surface.

14. The fitting of claim 12 wherein the ferrule, sleeve, crimp collar or similar locking device includes an inner surface, and the inner surface includes one or more ridges.

15. The fitting of claim 14 wherein the inner surface includes three ridges.

16. The fitting of claim 12 wherein the fitting includes a retention ring proximate to an end of the fitting.

17. The fitting of claim 16 wherein the ferrule, sleeve, crimp collar or similar locking device is configured to be crimped, compressed, swaged, deformed, threaded, or otherwise secured to the flexible tubes/hoses behind the retention ring.

18. The fitting of claim 12 wherein the fitting comprises a double sealing fitting connector, nut or locking that provides two fitting sealing points, said double sealing fitting connector, nut or locking comprising:
a stem mating face seal;
a stem pocket seal section; and
a nut or locking fitting pocket seal section.
